(19) United States
(12) Patent Application Publication
(10) Pub. No.: US 2017/0182938 A1
(43) Pub. Date: Jun. 29, 2017

(54) CHILD CAR SEAT SAFETY ELECTRICAL ALARM SWITCH ASSEMBLY

(71) Applicant: Wayne Calvin Byrd, I, Los Angeles, CA (US)

(72) Inventor: Wayne Calvin Byrd, I, Los Angeles, CA (US)

(73) Assignee: Dr. Wayne Calvin Byrd, I, Culver City, CA (US)

(21) Appl. No.: 14/583,676

(22) Filed: Dec. 27, 2014

(51) Int. Cl. B60Q 9/00; G08B 21/02; B60N 2/00

(52) U.S. Cl. CPC B60Q 9/00; B60N 2/002; G08B 21/02; B60N 2/28

(57) ABSTRACT

This Child Car Seat Safety Electrical Alarm Switch Assembly was invented to eliminate a very serious problem that we have worldwide. The problem is that Drivers of Vehicles from time to time have the need to transport small Children in a Car Seat that is strapped into the Vehicle. Too often when some Drivers exit the Vehicles they forget that the Child is left in the Car Seat. Subsequently, when the Driver realizes that the Child was left in the Car Seat, it is often too late to save the life of the Child. Usually, the windows in the Car or Vehicle are closed tightly. When the Temperature is elevated, it gets extremely hot in the Vehicle. Therefore, the Child dies from Heat Exhaustion. When it is extremely cold, however, the opposite occurs and the Child dies from freezing to death. This invention prevents either of these from happening, since it alerts the Drivers that the child is in the Car each time he or she opens the Car Door. This Alarm System activates, even, while the Ignition Switch is in the “Off” Position. So, this leaves no occasion for the Driver to claim that he did not know that the Child was left in the Car Seat or that he forgot. The Alarm System is equipped with a “Red Warning Light” on the Dashboard which can clearly be seen when the Door opens and the Child is in the Car Seat. If one does not hear the Alarm Switch, he certainly will be able to see the “Bright Red Light.” Therefore, he will know that it is required to remove the Child from the Child Seat in the Vehicle before leaving the premises of the Vehicle. This, then, saves the life of the Child.

### AUTOMOTIVE BATTERY

Number 2 is the Battery as is normally installed in Vehicles using the direct current (DC) systems.

### MASTER CONTROL SWITCH

Number 4 is the “Master Control Switch” which is a “Momentary Switch” that is a “Normally On Switch.” This Switch opens the Electrical Circuitry when the Driver's Side Door is closed. Therefore, when the door is closed, the Alarm is silent and Electricity is not flowing through the System. Once the door opens and a Child is in the Car Seat, the Alarm will activate instantaneously and Red Warning Light will illuminate simultaneously.

### INLINE FUSE HOLDER

Number 6 is the In Line Fuse and holder. In the event of an Electrical Shortage, this prevents the system from being damaged. Should something malfunction in the Electrical System, the Fuse will prevent the further transferring of Electricity through the System. This is a built in Safety Device.

### DISCONNECT PLUG

Number 8 is a built in Disconnect Plug for the entire System. This can be used for maintenance when one needs to disconnect the entire system.

### DISCONNECTED CHILD CAR SEAT SAFETY ELECTRICAL SWITCH

Number 10 is the Disconnected “Child Car Seat Safety Electrical Alarm Switch Assembly.” This Switch is mounted in the Child Car Seat. It is normally off. However, once the Child is placed in the seat, the pressure from the weight of the Child will activate the Switch and turn it on. Therefore, as long as the Child is in the Child Car Seat, the System is activated. However, no Electricity will flow to the Child Seat, until the Front Driver's Side Door is opened. Then, the Alarm will sound and the “Red Warning Light”, mounted in the Dashboard, will illuminate. If the Child Car Seat is left in the Vehicle, after having removed the Child, there is no need to disconnect the Power Cord. This Cord needs to be disconnected only is there is a need to remove the Car Seat from the Vehicle.

### THE ELECTRICAL ALARM SWITCH

Number 12 is the “Electrical Alarm Switch.” This Switch works as it is engaged by minimal pressure from the weight of the Child. This Switch is to be made into the Car Seat by the Manufacturers of Child Car Safety Seats. The Switch and the Adapter that will come in each Vehicle will be universally standard. This will insure that every Child Car Seat in the world will have the capability to be installed in every Vehicle mutually. So, this will be a unified effort of The Automotive Industry, and the Child Car Seat Manufacturers. This Switch is very safe. It has built in Safety Factors to prevent injury and problems. This Switch is compatible for all Child Car Seats and Seat Bases and will plug into the Energy Supply Line that will have been Standard Equipment on all Vehicles. This Switch comes with an Electrical Supply wiring that is of sufficient length to easily reach the Energy Supply Line to make the connection. This Switch is a “Normally Off Switch.” It comes on when activated by the weight of a Child being placed in it.

### THE ALARM SOUNDER

Number 14 is the “Alarm Sounder.” This rings with sufficient decibels to alert the Driver of the Vehicle that the Child is in the Car Seat, once the Front Driver's Door is opened. Simultaneously, the “Red Warning Light” comes on, as well.

### THE RED WARNING LIGHT

Number 16 is the “Red Warning Light.” This light illuminates when the Front Driver's Door is opened while a Child is in the Child Car Seat. If there is no Child in the Seat, the System will not activate. So, if someone drives a Vehicle with this System installed, if there is no Child in the Seat, the System is neutral. Neither the Red Warning Light nor the Alarm Sounder will active, unless there is a Child in the Child Car Seat.

### THE COMMON GROUND FROM THE BATTERY

Number 18 is the Common Ground from the Battery that supplies the Electricity for the System's Operation. The Energy supplied is Direct Current (DC) and not Alternating Current (AC). So, it is very safe.

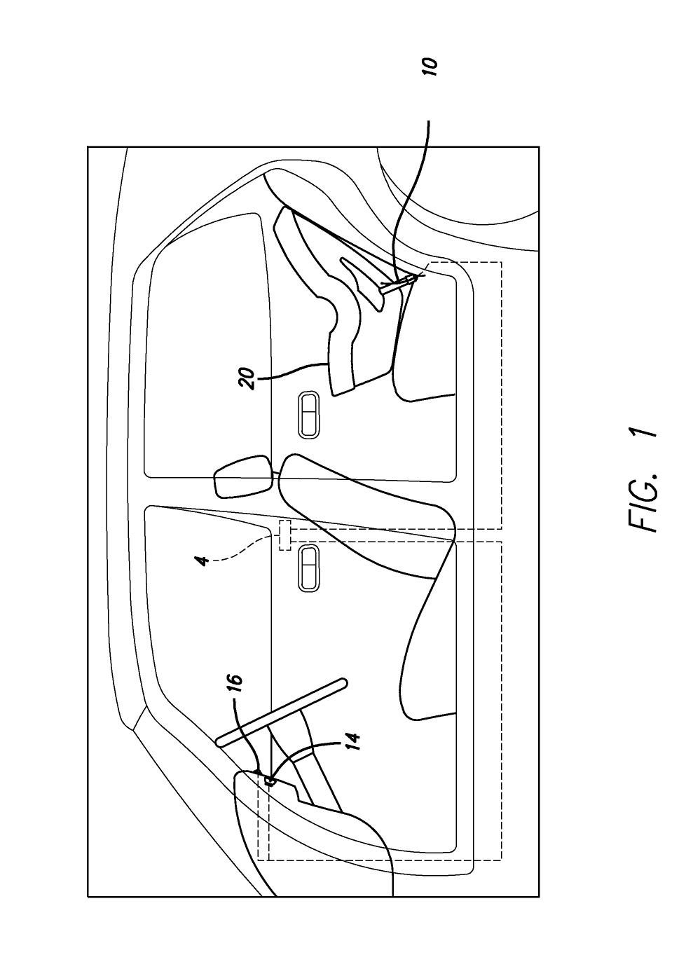

### FIG. 1

This is the Left Drivers Side View of the Automobile. Switch Number 4 is activated by the opening and closing of the Driver's Front Door. View Number 20 shows the Child Car Seat mounted on the right side of the rear seat of the car. This allows for an easy view, from the driver, to the child that is in the Car Seat.

### Vehicle Visual Side View (Drawing)

### MASTER CONTROL SWITCH

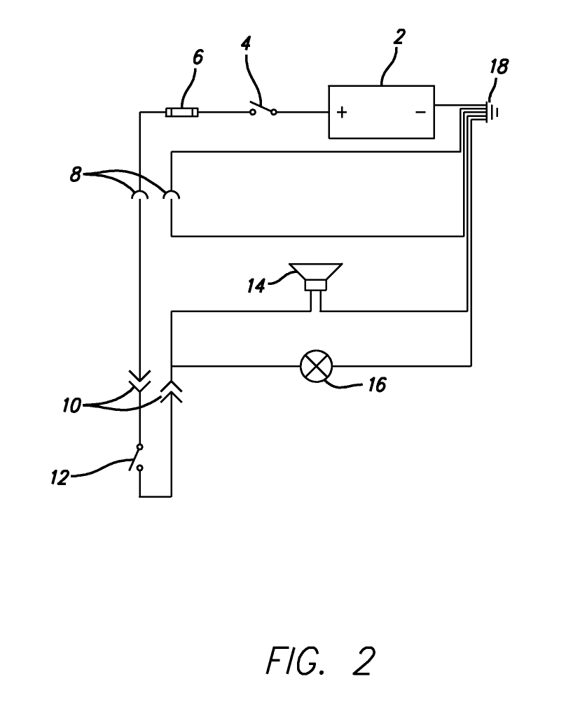

Number 4 is the “Master Control Switch” as viewed from the Driver's Side of the Vehicle. This Switch is described in FIG. 2, Number 4. See, FIG. 2, Number 4 for details.

### CONNECT AND DISCONNECT PLUG

Number 10 is the “Connect and Disconnect Plug.” When the Child Car Seat is anchored in the Vehicle by Seat Belts, the responsible person manually connects the Electrical Cord Plug of the Child Car Seat to the Standard Electrical Power Supply of the Vehicle. These are placed in a position that is easily accessible. This promotes the willingness to do this each time the Car Seat is placed in the Vehicle. This is a part of the Safety Network. The Child Car Seat does not have to be removed, from the Vehicle, each time that the Child is removed. Then, there would be no need to disconnect the Safety Switch. The System does not activate, until a Child is placed into the Child Car Seat. This is the connection for the Switch described in FIG. 2, Number 12.

### THE ALARM SOUNDER

Number 14 is the “Alarm Sounder” as described in FIG. 2, Number 14. It is mounted under the Dashboard of Vehicles. This is a visual view from the Drivers Side of the Vehicle. See, FIG. 2, Number 14 details.

### THE RED WARNING LIGHT

Number 16 is the “Red Warning Light” as described in FIG. 2, Number 16. It illuminates simultaneously with the Sounding of the Child Car Seat Alarm. This is a visual view from the Driver's Side of the Vehicle. See, FIG. 2, number 16 for details.

### THE CHILD CAR SAFETY SEAT

Number 20 is the Child Car Safety Seat. This Seat is secured in the Vehicle by Standard Seat Belts. These Seats vary in appearance, as they are made by many different manufacturers. However, the Alarm System Switch will fix in all of them and the Bases, as well.

1. The first overall usage of Vehicle Battery Electrical Systems in conjunction with an installed Seat Pressure Electric Alarm Switch that is activated by the opening of the Driver's Side Door.

2. The first usage of two (2) equal and opposite Switches to produce the correct timing sequence to create absolute perfection in alarm probability.

3. The first usage of an Electrical Plug Connector attached to the Alarm Switch in the Child Car Seat or Detachable Seat Base to the Electrical Power Source provided in the Vehicle Wiring System.

4. The first Alarm System for a Child Safety Seat that utilizes an Alarm and a Red Warning Light simultaneously to alert the Driver that a Child is in the Car Seat.

5. The first Alarm for a Child Car Seat that has neither positive nor negative effect on the Electrical System, unless the Child is in the Car Seat.

6. The utilization of any devices, whether Electrical, Mechanical, Digital, or Analog, for the purpose of being an Alarm or Safety Device designed for the Child Car Seat, even if the Seat is called by another name.

7. The application of any or all of the Systems and or Devices named in this Document to include the parts that are to be installed in Automotive Vehicles.

8. Any unit pertaining to a Safety Alarm System that is associated with Child Car Seats, even if the Battery that supplies the Electricity is portable and has no connection to the Vehicle's Electrical Network.

9. Any device or devises, that may be used for the purpose of alerting the Driver of a Vehicle, upon opening the door, stopping the Vehicle, turning off the Ignition Switch, or by any other means whatsoever that there is a Child in the Car Safety Seat.
